(19) United States
(12) Patent Application Publication
(10) Pub. No.: US 2025/0369494 A1
(43) Pub. Date: Dec. 4, 2025

(54) BRAKE CLIP

(71) Applicant: ZF Active Safety GmbH, Koblenz (DE)

(72) Inventor: Paul Wecker, Limburg (DE)

(21) Appl. No.: 19/226,243

(22) Filed: Jun. 3, 2025

(30) Foreign Application Priority Data
Jun. 4, 2024 (DE) 102024115443.8

(51) Int. Cl. F16D 65/097; F16D 55/00; F16D 65/00; F16D 127/02

(52) U.S. Cl. CPC F16D 65/0978; F16D 65/0056; F16D 65/0979; F16D 2055/0008; F16D 2127/02; F16D 2200/0004

(57) ABSTRACT

The present invention relates to a brake clip 1, a corresponding brake carrier 50 and a corresponding floating-caliper brake 100. The brake clip 1 has a width b1 and a U-shaped portion 10 for insertion into an axially extending guide channel 60 of a brake carrier 50 of the disc brake 100. The U-shaped portion 10 is adjoined by a first support portion for supporting the brake clip 1 against a first support rail 62 which adjoins the guide channel 60, by a spring portion 22, by a second support portion 25 for supporting the brake clip 1 against a second support rail 70 which adjoins the guide channel 60, and by a first fixing portion 30 for fixing the brake clip 1, wherein the first fixing portion 30, or the first fixing portion 30 and a part of the second support portion 25, is cut out such that the width of the metal sheet remaining adjacent to the cutout 32 lies in a range from 0.4 times to 0.6 times the width b1.

### TECHNICAL FIELD

The invention relates to a brake clip for a motor vehicle disc brake. The invention also relates to a brake carrier for such a motor vehicle disc brake, and to a motor vehicle disc brake per se. Motor vehicle disc brakes are commonly designed as a floating-caliper brakes or sliding-caliper brakes. The invention thus relates in particular to motor vehicle brakes designed as floating-caliper brakes.

### BACKGROUND

A floating-caliper brake for motor vehicles commonly has a brake carrier and an axially movably mounted brake caliper coupled to the brake carrier, said brake caliper commonly being designed as a sliding caliper and often also being referred to as a housing, because the brake actuator is installed therein. A fully assembled floating-caliper brake furthermore has brake pads that are mounted axially movably in the brake carrier. For this purpose, the brake pads commonly have carrier plates having brake pad lugs which are guided in guide channels of the brake carrier and in the region of said guide channels with the assistance of brake clips.

An associated brake carrier commonly has a brake disc slot that provides space for an associated brake disc. The brake disc slot has a first inner side on one side of the brake disc and a second inner side on the other side of the brake disc. In the installed state, the inner sides each face towards the brake disc. The brake carrier also commonly has a first outer wall, which forms the opposite side in relation to the first inner side, such that a wall is formed in between. In an installed state in a motor vehicle, the first outer wall points for example towards the outside of the vehicle. Analogously, a wall is also formed between the second inner side and a corresponding second outer side of the brake carrier, and, if the first outer side points towards the outside of the vehicle, the second outer side is oriented towards the chassis or into the wheel well. As already mentioned, an associated brake carrier furthermore has guide channels, which are oriented in the axial direction. The expression “axially” or in the “axial direction” relates to the movement direction of associated brake pads towards a brake disc or away from the brake disc. That is to say, the axial direction extends parallel to the axis of rotation of an associated brake disc. This means that the longitudinal extent of the guide channels extends in the axial direction, such that brake pad lugs of associated brake pads can be received and moved axially in the associated guide channels.

Brake clips are commonly used in order, in interaction with the guide lugs of the brake pads, to ensure that the brake pads can move freely at all times. Furthermore, brake clips perform further functions such as vibration decoupling, radial and tangential preloading of the brake pads, retraction of the brake pads, and wear compensation. Brake clips are arranged in the region of each of the guide channels and are commonly inserted with a U-shaped portion into said guide channels. Such a brake clip is disclosed for example in document DE 102012010932 A1.

### SUMMARY

It is an object of the present invention to provide an inexpensive brake clip which can be easily and reliably installed and positioned and which remains securely in the installed position. It is also an object to provide a corresponding brake carrier and a corresponding disc brake.

The stated object is achieved according to the invention by means of a brake clip having the features of claim 1, by means of a brake carrier having the features of claim 9, and by means of a motor vehicle disc brake having the features of claim 11. Dependent claims 2 to 8, 10 and 12 specify advantageous embodiments of the invention.

Where a brake carrier or a motor vehicle disc brake and the constituent parts thereof, such as a brake pad, are referred to below in the context of the brake clip, this is done for the purposes of clearly defining the various elements and properties of the brake clip and presenting the advantages in relation to the prior art. This applies analogously to the description of the brake carrier given further below, where reference is made there to the brake clip or to a motor vehicle disc brake that is associated with said brake carrier in the installed state. This, too, is done for the purposes of clearly defining the various elements of the brake carrier and presenting the advantages of the invention in relation to the prior art.

The brake clip according to the invention is provided for a motor vehicle disc brake. It is preferably provided for a floating-caliper brake of a motor vehicle and even more preferably for a sliding-caliper brake of a motor vehicle. The brake clip is formed as a shaped sheet-metal part and has a width b1 in an axial direction, said width being defined by the distance between an inner longitudinal edge and an outer longitudinal edge. Since the brake clip is formed as a shaped sheet-metal part, it has a plurality of bending edges and, in a developed state, has an elongate shape with the width b1 and with a longitudinal extent greater than the width b1, whereby the edges that define the width b1 are referred to as inner and outer longitudinal edges. The brake clip is preferably designed such that the inner longitudinal edge is oriented towards an inner side of the brake carrier and the outer longitudinal edge is oriented towards a corresponding outer side of the brake carrier.

The brake clip has a U-shaped portion, which has a first limb, a second limb and a connecting portion connecting the first and the second limb, for insertion into an axially extending guide channel of a brake carrier, wherein a first limb end of the U-shaped portion is adjoined by a first support portion for supporting the brake clip against a first support rail which adjoins the guide channel and by a spring portion for at least radially supporting a brake pad which is comprised by an associated motor vehicle disc brake, wherein the second limb end of the U-shaped portion is adjoined by a second support portion for supporting the brake clip against a second support rail which adjoins the guide channel and by a first fixing portion for fixing the brake clip. Proceeding from the spring portion, the aforementioned brake clip portions are situated as follows along the longitudinal extent of said brake clip as seen in the developed state (see the explanation above): spring portion—first support portion—first limb—connecting portion—second limb—second support portion-fixing portion. Here, each of the aforementioned individual portions is bent into a different orientation than the portion mentioned before it, that is to say said portions are each bent at an angle relative to the preceding portion.

Furthermore, the first fixing portion, or the first fixing portion and a part of the second support portion, is cut out such that the width of the metal sheet remaining adjacent to the cutout lies in a range from 0.4 times to 0.6 times the width (b1). The width of the metal sheet remaining adjacent to the cutout preferably corresponds to 0.5 times the width (b1). This means that the cutout may be situated exclusively in the first fixing portion, but also that the cutout may extend into a part of the second support portion. The cutout may also preferably extend from the first fixing portion into the angled bend, or into the transition region between the first fixing portion and the second support portion, such that the first fixing portion can perform its support function unimpaired.

Owing to the cutout and owing to the stated width of the first fixing portion, the brake clip can be easily installed. Specifically, the first fixing portion provides better grip and is more robust in relation to fixing elements from the prior art. Owing to the configuration of the first fixing portion and the width thereof, the brake clip according to the invention also offers good stability and a permanent holding force. The configuration of the width of the first fixing portion offers cost advantages for the production of the brake clip, because relatively little sheet metal is required.

The width of the first fixing portion is preferably delimited by a first fixing portion edge adjoining the cutout and by a second fixing portion edge situated opposite the cutout, wherein the first fixing portion edge is designed to be placed in contact with a corresponding abutment surface of the second support rail. In conjunction with the further aforementioned features of the brake clip and with the features yet to be discussed below, the first fixing portion edge assists in achieving easy and reliable positioning of the brake clip on a brake carrier which has a corresponding abutment surface.

The first fixing portion preferably extends at right angles to the second support portion and so as to proceed therefrom, with a free end approaching the connecting portion. That is to say, the fixing portion forms one end of the brake clip when considering the longitudinal extent of the brake clip, and the spring portion correspondingly forms the other end of the brake clip. The first fixing portion thus has a free end which can be well positioned on the brake carrier for fixing purposes.

The first fixing portion edge preferably extends at right angles to the axial direction. This allows the first fixing portion edge to be easily and reliably installed and positioned on a corresponding abutment surface of a support rail of a brake carrier.

The second fixing portion edge of the first fixing portion preferably extends flush with the outer longitudinal edge of the brake clip. That is to say, in the developed state of the brake clip, the outer longitudinal edge is a continuous edge as far as the end of the first fixing portion, or the longitudinal edge and the second fixing portion edge transition into one another.

Preferably, the first support portion and the second support portion extend at right angles to the first and the second limb of the U-shaped portion. It is also possible for only the first support portion to extend at right angles to the first or the second limb, or for only the second support portion to extend at right angles to the first or the second limb.

The brake clip preferably has, for the fixing thereof, a second fixing portion which extends from the inner longitudinal edge in the region of the connecting portion, so as to be bent at right angles to the connecting portion, in the opposite direction to the direction of extent of the first and of the second limb, wherein the corresponding bending edge extends at right angles to the axial direction. In combination with the first fixing portion and in particular with the first fixing portion edge, particularly reliable fixing of the brake clip to a brake carrier is thus achieved. Owing to its configuration, the second fixing portion can exert a holding force on the brake carrier; a corresponding reaction force arises between the first fixing portion edge and a corresponding abutment surface of the brake carrier. The first fixing portion having the possible described embodiments however simultaneously also ensures particularly good and permanent positioning of the brake clip.

The brake clip preferably has a spring arm for brake pad resetting purposes, said spring arm extending from the outer longitudinal edge in the region of the first limb into the interior of the U-shaped portion.

Furthermore, in the transition region between the first limb and the connecting portion, there is preferably a holding claw, which protrudes from the U-shaped portion, for the purposes of fixing the brake clip in the guide channel.

The brake carrier according to the invention is provided for a motor vehicle disc brake. It is preferably provided for a floating-caliper brake of a motor vehicle and even more preferably for a sliding-caliper brake of a motor vehicle. The brake carrier has at least one outer side, and has a brake disc slot having at least one inner side facing towards the brake disc slot. The brake carrier furthermore has at least one axially extending guide channel for receiving a brake clip according to the preceding description, and also a first support rail, which adjoins the at least one guide channel on one side thereof, for supporting the brake clip by means of the first support portion, and also a second support rail, which adjoins the at least one guide channel on the other side thereof, for supporting the brake clip by means of the second support portion. As already described in the introduction, a brake pad lug of a brake pad can be received in such a guide channel, and the guide channel has an axial extent and serves for the guidance and axial mobility of a brake pad. The guide channel is thus also an axially extending groove having an axially extending groove opening, such that there is inevitably a first side along the guide channel and a second side which is situated opposite the first guide channel side in relation to the axially extending opening of the guide channel.

The second support rail furthermore has, in the axial direction, a width b2 defined by the distance between an outer rail side, which is arranged on the at least one outer side of the brake carrier, and an inner rail side, which is arranged on the at least one inner side of the brake carrier, wherein the second support rail is formed by a first wall, which is also a wall of the at least one guide channel, by a second wall, which adjoins and extends at right angles to the first wall, and by a third wall, which adjoins the second wall and extends at a distance from and parallel to the first wall, wherein the third wall is of stepped form such that the third wall has a raised level and a lowered level oriented parallel to the raised level, wherein an abutment surface extends at right angles to the raised and lowered levels and at right angles to the axial direction and, together with the inner rail side, defines a width b3 of the raised level.

The width b3 of the raised level lies in a range from 0.4 times to 0.6 times the width b2 of the second support rail. The width b3 of the raised level preferably corresponds to 0.5 times the width b2 of the second support rail. With regard to the orientation of the third wall relative to the second wall, the claim for protection also encompasses an angle other than 90°, as long as said angle lies in the range of demoulding angles for metal casting processes. Preferably, the raised level and the lower level each constitute a surface. The lowered level is preferably a planar surface.

The second support rail preferably has, adjacent to the lowered level, a receiving space for receiving the first fixing portion of the brake clip, wherein the receiving space is not delimited by the second wall and is not delimited by the outer rail side. The edge profile of the second wall is thus stepped in the region of the raised level and of the lowered level. That is to say, the receiving space constitutes a free space which is open to the second wall and to the inner rail side, or which is not delimited by the second wall and the inner rail side.

These embodiments of the brake carrier discussed above, and in particular the design of the second support rail, have the advantage that the brake clip according to the invention can be easily and precisely installed and positioned. The receiving space and the abutment surface are adapted to the first fixing portion such that the fixing portion can be easily inserted in the receiving space and such that the brake clip remains securely in the inserted position. The only partial lowering of the third wall by way of the lowered level can be produced inexpensively in relation to solutions from the prior art.

The motor vehicle disc brake according to the invention is designed preferably as a floating-caliper brake, and even more preferably as a sliding-caliper brake. The motor vehicle disc brake has a brake carrier according to any one of the embodiments described above and at least one brake clip according to any one of the embodiments described above. Here, the brake clip is connected to the brake carrier such that the U-shaped portion of the brake clip is arranged in the guide channel, such that the first support portion lies against the first support rail, such that the second support portion lies against the second support rail, such that the first fixing portion projects into the receiving space, in particular is in contact with the lowered level, and such that the first fixing portion edge of the first fixing portion is in contact with the abutment surface of the second support rail. This arrangement has the advantage that the brake clip according to the invention can be easily and precisely installed and positioned, and that the fixing portion remains securely in the inserted position. The contact of the first fixing portion with the lowered level generates additional fixing of the brake clip to the second support rail. The first fixing portion and the second limb of the brake clip are preferably designed such that, together, they exert a clamping force on the second support rail, which clamping force acts transversely to the axial direction.

Preferably, the brake clip has a second fixing portion which extends from the inner longitudinal edge in the region of the connecting portion, so as to be bent at right angles thereto, in the opposite direction to the direction of extent of the first and of the second limb, wherein the corresponding bending edge extends at right angles to the axial direction, wherein the second fixing portion lies against the at least one inner side of the brake carrier and exerts a force thereon such that the brake clip, in interaction with a force exerted by the first fixing portion on the abutment surface of the second support rail, is fixed to the brake carrier. The force that the second fixing portion exerts on the at least one inner side of the brake carrier also acts, approximately as a reaction force, between the first fixing portion and the abutment surface. The two fixing portions thus generate a clamping action by which the brake clip is permanently securely held on the brake carrier.

The advantages and effects already mentioned with regard to the brake clip and the brake carrier also apply to the disc brake according to the invention.

### BRIEF DESCRIPTION OF THE DRAWINGS

Further features, advantages and possible uses of the present invention will become apparent from the following description of an exemplary embodiment and the schematic FIG. 1.

FIG. 1 shows an embodiment of the brake clip according to the invention, of the brake carrier according to the invention and of the motor vehicle disc brake according to the invention.

### DESCRIPTION

In the exemplary embodiment illustrated, the brake clip 1 has been shaped from an elongate sheet-metal blank and has been bent at an angle multiple times, transversely with respect to its longitudinal extent. Starting at one end, the brake clip 1 has a spring portion 22, which at one end has a domed portion for pressing against a brake pad and its other end adjoins a first support portion 20 via a 90° bend. The first support portion 20 is adjoined, via a 90° bend, by a first limb 12 of the U-shaped portion 10, the extent of which points away from the spring portion 22. The first limb 12 is adjoined, via a 90° bend, by a connecting portion 14, and a second limb 16 proceeds from said connecting portion via a 90° bend, such that the first limb 12, the connecting portion 14 and the second limb 16 form the U-shaped portion 10. The second limb 16 is adjoined, via a 90° bend, by a second support portion 25. A first fixing portion 30 proceeds from the second support portion 25 via a 90° bend. Said first fixing portion extends parallel to the first and the second limb 12, 16 and thus so as to approach the connecting portion to a certain extent. The first fixing portion 30 is of approximately equal length to the first and the second limb 12, 16 and has a free end 38.

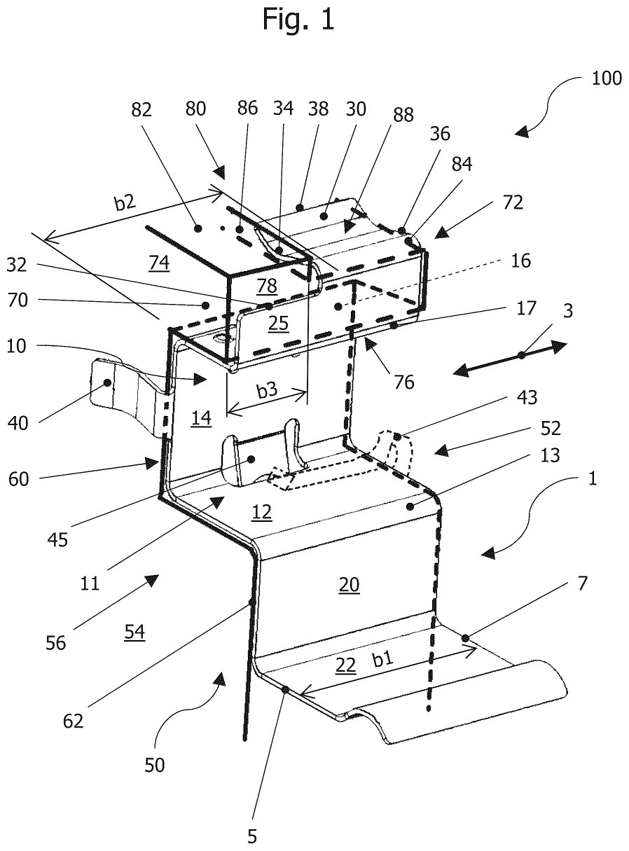

The brake clip 1 has a width b1 which is constant along most of the aforementioned brake clip portions and which is delimited by an inner longitudinal edge 5 and an outer longitudinal edge 7. The first fixing portion 30 is however cut out proceeding from the centre of the brake clip 1 with respect to the width b1. That is to say, the cutout 32 is situated on the left-hand side as seen in FIG. 1, such that the width of the remaining metal sheet of the first fixing portion 30 amounts to half of the width b1. The cutout 32 furthermore extends from the free end 38 to the point where the angled bend to the second support portion 25, where the first fixing portion 30 is bent at an angle relative to the second support portion 25, begins. On the side of the cutout 32, the first fixing portion 30 has a first fixing portion edge 34. On the side situated opposite the first fixing portion edge 34, the first fixing portion 30 has a second fixing portion edge 36 that forms a continuous edge profile with the outer longitudinal edge 7.

The brake clip 1 furthermore has a second fixing portion 40 which extends from the connecting portion 14 in the opposite direction to the two limbs 12, 16 and transversely with respect to the axial direction 3. The second fixing portion 40, together with the first fixing portion 30 and its first fixing portion edge 34, forms a clamping mechanism by which the brake clip 1 can be easily installed on the brake carrier 50 and is securely held thereon. The axial direction 3 is illustrated using a double arrow.

The brake clip 1 furthermore has a holding claw 45 which, in the angled bend between the first limb 12 and the connecting portion 14, projects outwards from the brake clip 1. Said holding claw 45 acts as an additional fixing means. Optionally, and therefore as illustrated using dashed lines, the brake clip 1 has a spring arm 43 for resetting, and possibly compensating for wear of, the brake pad.

The brake carrier 50, which is part of the superordinate motor vehicle disc brake 100, is illustrated in FIG. 1 using somewhat thicker lines and dashed lines. Where the U-shaped portion 10 of the brake clip 1 is situated, the brake carrier 50 has a guide channel 60. The brake clip 1 is inserted with its U-shaped portion 10 into said guide channel 60. The guide channel 60 extends axially from an outer side 52 to an inner side 56 of the brake carrier 50. The inner side 56 is where the brake disc slot 54 is also situated. FIG. 1 illustrates only a detail of the brake carrier 50, and it is clear that the brake carrier 50 may have several such arrangements. A corresponding brake carrier 50 preferably has four such arrangements or similar arrangements.

Referring to FIG. 1, a first support rail 62 is situated below the guide channel 60 and a second support rail 70 is situated above the guide channel 60. The brake clip 1 is supported by means of its first support portion 20 on the first support rail 62. The brake clip 1 is supported by means of its second support portion 25 on the second support rail 70. The second support rail 70 is formed by a first wall 76, a second wall 78 and a third wall 80. The first wall 76 is simultaneously also a wall of the guide channel 60, against which the second limb 16 of the brake clip 1 lies. The third wall 80 extends parallel to and is spaced apart from the first wall 76. The second wall 78 connects the first and the third wall 76, 80. Viewing the second wall 78, its edge extends in stepped fashion in the transition region to the third wall 80, because the third wall has a depression. That is to say, the third wall 80 has a raised level 82 on the left-hand side as seen in FIG. 1, and has a lowered level 84 on the right-hand side. The second support rail 70 has a width b2 defined by an outer rail side 72, which is situated on an outer side 52 of the brake carrier, and by an inner rail side 74, which is situated on an inner side 56 of the brake carrier. The raised level 82 has a width b3 defined by the inner rail side 74 and by an abutment surface 86 extending parallel to and at a distance from said inner rail side.

The abutment surface 86 arises owing to the height offset between the raised level 82 and the lowered level 84. That is to say, the abutment surface 86 connects the raised level 82 and the lowered level 84. The abutment surface 86 extends as a planar surface orthogonally with respect to the axial direction 3 and orthogonally with respect to the lowered level 84. The step, that is to say the abutment surface 86, is situated in the middle of the width of the second support rail 70. That is to say, the width b3 is 0.5 times the width b2. The stepped configuration gives rise, above the lowered level 84, to a receiving space 88 into which the first fixing portion 30 of the brake clip 1 projects with its free end 38. The first fixing portion 30 is of rounded arcuate form such that it presses by means of a convex portion, which is situated between the angled bend and the free end 38, against the lowered level 84. The brake clip 1 is correspondingly pulled with its second limb 16 against the first wall 76.

The first fixing portion 30 is furthermore pressed with its first fixing portion edge 34 against the abutment surface 86, because the second fixing portion 40 presses with a spring force against the inner side 56. The brake clip 1 is thus firmly clamped against the brake carrier 50 and in particular against the second support rail 70. Owing to the special design of the first fixing portion 30, as described in detail above, in interaction with the second fixing portion 30, the brake clip 1 can be easily installed on the brake carrier 50 and is permanently and securely held in the desired position thereon.

1. Brake clip (1) for a motor vehicle disc brake (100), in particular for a floating-caliper brake,
wherein the brake clip (1) is formed as a shaped sheet-metal part and has a width (b1) in an axial direction (3), said width being defined by the distance between an inner longitudinal edge (5) and an outer longitudinal edge (7),
wherein the brake clip (1) has a U-shaped portion (10), which has a first limb (12), a second limb (16) and a connecting portion (14) connecting the first and the second limb (12, 16), for insertion into an axially extending guide channel (60) of a brake carrier (50),
wherein a first limb end (13) of the U-shaped portion (10) is adjoined by a first support portion for supporting the brake clip (1) against a first support rail (62) which adjoins the guide channel (60) and by a spring portion (22) for at least radially supporting a brake pad which is comprised by an associated motor vehicle disc brake (100),
wherein the second limb end (17) of the U-shaped portion (10) is adjoined by a second support portion (25) for supporting the brake clip (1) against a second support rail (70) which adjoins the guide channel (60) and by a first fixing portion (30) for fixing the brake clip (1),
wherein the first fixing portion (30), or the first fixing portion (30) and a part of the second support portion (25), is cut out such that the width of the metal sheet remaining adjacent to the cutout (32) lies in a range from 0.4 times to 0.6 times the width (b1).

2. Brake clip (1) according to claim 1,
wherein the width of the first fixing portion (30) is delimited by a first fixing portion edge (34) adjoining the cutout (32) and by a second fixing portion edge (36) situated opposite the cutout (32), wherein the first fixing portion edge (34) is designed to be placed in contact with a corresponding abutment surface (86) of the second support rail (70).

3. Brake clip (1) according to claim 2,
wherein the first fixing portion (30) extends at right angles to the second support portion (25) and so as to proceed therefrom, with a free end (38) approaching the connecting portion (14).

4. Brake clip (1) according to claim 1,
wherein the first fixing portion edge (34) extends at right angles to the axial direction (3).

5. Brake clip (1) according to claim 1,
wherein the second fixing portion edge (36) of the first fixing portion (30) extends flush with the outer longitudinal edge (7) of the brake clip (1).

6. Brake clip (1) according to claim 1,
wherein the first support portion (20) and/or the second support portion (25) extends at right angles to the first and/or the second limb (16) of the U-shaped portion (10).

7. Brake clip (1) according to claim 1,
wherein the brake clip (1) has, for the fixing thereof, a second fixing portion (40) which extends from the inner longitudinal edge (5) in the region of the connecting portion (14), so as to be bent at right angles to the connecting portion (14), in the opposite direction to the direction of extent of the first and of the second limb (12, 16), wherein the corresponding bending edge extends at right angles to the axial direction (3).

8. Brake clip (1) according to claim 1,
wherein the brake clip (1) has a spring arm (43) for brake pad resetting purposes, said spring arm extending from the outer longitudinal edge (7) in the region of the first limb (12) into the interior (11) of the U-shaped portion (10), and/or wherein, in the transition region between the first limb (12) and the connecting portion (14), there is a holding claw (45), which protrudes from the U-shaped portion (10), for the purposes of fixing the brake clip (1) in the guide channel (60).

9. Brake carrier (50) for a motor vehicle disc brake (100), in particular for a floating-caliper brake,
having at least one outer side (52), having a brake disc slot (54), and having at least one inner side (56) facing towards the brake disc slot (54),
having at least one axially extending guide channel (60) for receiving a brake clip (1) according to claim 1, having a first support rail (62),
which adjoins the at least one guide channel (60) on one side thereof, for supporting the brake clip (1) by means of the first support portion (20), and having a second support rail (70), which adjoins the at least one guide channel (60) on another side thereof, for supporting the brake clip (1) by means of the second support portion (25),
wherein the second support rail (70) has, in the axial direction (3), a width (b2) defined by the distance between an outer rail side (72), which is arranged on the at least one outer side (52) of the brake carrier, and an inner rail side (74), which is arranged on the at least one inner side (56) of the brake carrier (50),
wherein the second support rail (70) is formed by a first wall (76), which is also a wall of the at least one guide channel (60), by a second wall (78), which adjoins and extends at right angles to the first wall (76), and by a third wall (80), which adjoins the second wall (78) and extends at a distance from and parallel to the first wall (76),
wherein the third wall (80) is of stepped form such that the third wall (80) has a raised level (82) and a lowered level (84) oriented parallel to the raised level (82), wherein an abutment surface (86) extends at right angles to the raised and lowered levels (82, 84) and at right angles to the axial direction (3) and, together with the inner rail side (74), defines a width (b3) of the raised level (82),
wherein the width (b3) of the raised level (82) lies in a range from 0.4 times to 0.6 times the width (b2) of the second support rail (70).

10. Brake carrier (50) according to claim 9,
wherein the second support rail (70) has, adjacent to the lowered level (84), a receiving space (88) for receiving the first fixing portion (30) of the brake clip (1), wherein the receiving space (88) is not delimited by the second wall (78) and is not delimited by the outer rail side (72), and/or wherein the edge profile of the second wall (78) is stepped in the region of the raised level (82) and of the lowered level (84).

11. Motor vehicle disc brake (100), in particular floating-caliper brake,

10. brake carrier (50) according to claim 10 and having at least one brake clip (1), the brake clip (1) being formed as a shaped sheet-metal part and having a width (b1) in an axial direction (3), said width being defined by the distance between an inner longitudinal edge (5) and an outer longitudinal edge (7),
wherein the brake clip (1) has a U-shaped portion (10), which has a first limb (12), a second limb (16) and a connecting portion (14) connecting the first and the second limbs (12, 16), for insertion into an axially extending quide channel (60) of the brake carrier (50),
wherein a first limb end (13) of the U-shaped portion (10) is adjoined by a first support portion for supporting the brake clip (1) against the first support rail (62) which adjoins the guide channel (60) and by a spring portion (22) for at least radially supporting a brake pad,
wherein the second limb end (17) of the U-shaped portion (10) is adjoined by a second support portion (25) for supporting the brake clip (1) against the second support rail (70) which adjoins the guide channel (60) and by a first fixing portion (30) for fixing the brake clip (1),
wherein the first fixing portion (30), or the first fixing portion (30) and a part of the second support portion (25), is cut out such that the width of the metal sheet remaining adjacent to the cutout (32) lies in a range from 0.4 times to 0.6 times the width (b1),
wherein the width of the first fixing portion (30) is delimited by a first fixing portion edge (34) adjoining the cutout (32) and by a second fixing portion edge (36) situated opposite the cutout (32), wherein the first fixing portion edge (34) is designed to be placed in contact with the corresponding abutment surface (86) of the second support rail (70) wherein the brake clip (1) is connected to the brake carrier (50) such that the U-shaped portion (10) is arranged in the guide channel (60), such that the first support portion (20) lies against the first support rail (62), such that the second support portion (25) lies against the second support rail (70), such that the first fixing portion (30) projects into the receiving space (88), in particular is in contact with the lowered level (84), and such that the first fixing portion edge (34) of the first fixing portion (30) is in contact with the abutment surface (86) of the second support rail (70).

12. Motor vehicle disc brake (100) according to claim 11, wherein the brake clip (1) has a second fixing portion (40) which extends from the inner longitudinal edge (5) in the region of the connecting portion (14), so as to be bent at right angles thereto, in the opposite direction to the direction of extent of the first and of the second limb (12, 16), wherein the corresponding bending edge extends at right angles to the axial direction (3), wherein the second fixing portion (40) lies against the at least one inner side (56) of the brake carrier (50) and exerts a force thereon such that the brake clip (1), in interaction with a force exerted by the first fixing portion (30) on the abutment surface (86) of the second support rail (70), is fixed to the brake carrier (50).
